(19) United States
(12) Patent Application Publication
(10) Pub. No.: US 2002/0166312 A1
(43) Pub. Date: Nov. 14, 2002

(54) Air cleaner assembly with disposable environmentally friendly filter element

(76) Inventor: Albert Caroll Phelps, Eau Claire, WI (US)

Correspondence Address: ALBERT C. PHELPS, 1121 FLORENCE AVE, EAU CLAIRE, WI, 54703, US

(21) Appl. No.: 10/116,636

(22) Filed: Apr. 4, 2002

Related U.S. Application Data
(60) Provisional application No. 60/281,879, filed on Apr. 5, 2001.

(51) Int. Cl. B01D 46/52

(52) U.S. Cl. 55/497; 55/502

(57) ABSTRACT

An improved air cleaner assembly for large displacement stationary engines provides for an included environmentally friendly disposable filter element containing substantially no chlorine compounds or structural metal supports which upon incineration or landfilling become undesireable chemical compounds. Improved sealing results by creating novel gasket compression control both radially and by a face seal by use of permanent metal components which are not discarded as before. Excessive compression of the gasket material is prevented by structure integral to the air cleaner assembly, and support of the filter element is external within the air cleaner assembly rather than internal within the filter element, thus eliminating the manufacturing cost of metal components previously discarded as integral to the filter element upon replacement of the disposable filter element.

### CROSS REFERENCE TO RELATED APPLICATION

This application is entitled to the benefit of Provisional Patent Application Serial No. 60/281,879, Filed Apr. 5, 2001.

### BACKGROUND

1. Field of Invention

The invention relates to an improved air cleaner assembly for internal combustion engines utilizing pleated media panel type air filter elements whose narrower dimension exceeds 10 inches in width.

2. Prior Art

Large stationary engines typically found in the extractive operations of the petroleum industry are used in the field for various power applications such as compression of natural gas, pumping operations, and electrical power generation among others. Such engines are often used in harsh environments such as deserts, where extreme loads of particulate matter occur frequently and must be trapped by air filter elements within the air cleaner assembly. These engines are large displacement engines requiring large volumes of combustion air. As a result, the densely pleated panel type air filter element with large surface area has been industry standard as it gives maximum cleaning of the airstream while being a rugged unit which must survive heavy loading of contaminates, yet be easily accessible for replacement. Further complicating the operating conditions are rapidly shifting loads on the engine, causing pulsations on mass flow of the intake air, subjecting the filter element to large flexions unless strongly supported.

From such conditions, a more or less standard configuration of the replaceable air cleaner element has evolved.

Typical construction consists of a densely pleated media core; on the outlet face of the filter element, an expanded metal supporting structure, with a sheet metal retaining brace, joined thereto; a completely enclosing sheet metal frame on all four edges, with large amounts of polyvinyl chloride based adhesive to seal and retain the edges of the pleated filter media. Frequently on the inlet face additional sheetmetal strips are glued or welded across the inlet face to help minimize damage from occasional backfire of the engine. It is not uncommon to find an additional expanded metal across the inlet face of the filter assembly. In addition, due to manufacturing variances in the plenum or housing for the air intake, some gasketing on at least one of the faces of the air cleaner element must be emplaced to provide complete sealing so that only filtered air reaches the engine intake manifold.

In general, the air cleaner element must survive extreme conditions in an unattended state, hence the rugged construction This rugged construction comes at a price. This element is intended to be disposable in nature, as most field conditions do not allow for washing or otherwise maintaining a cleanable element. Each time such a unit is replaced, a significant amount of undesirable metals forming the internal support structure and adhesives generally containing chlorine and plasticizer are placed in the landfill or more often in other areas of the world in the incinerator.

This environmental loading in more populous areas of the world, particularly in Europe, has led to pay-as-you-pollute regulation as well as punitive associated costs, necessitating significant disposal expense for the user of the present air cleaner system. Additionally, many new installations are sited in regions with little or no infrastructure such as off-shore rigs and in the Arctic. Transportation of essential incoming operating supplies and the mandatory removal of wastes is exceptionally costly. These factors will become ever more important throughout the world as newer global environmental treaty regulations begin to take effect in the next few years.

Teachings Regarding Environmental Concerns

Such concerns have been anticipated in the design of oil filter cartridges. Teaching of environmental concerns are illustrated in U.S. Pat. No. 5,702,602 (Brown) and related patent.

Similar concerns with air filters is expressed in U.S. Pat. No. 5,320,655(Ernst), originally filed in Switzerland.

Teachings Regarding Pleat Support

Pleated media filter elements of large surface area having a width of 6 to 8 inches or greater necessitated adding internal stiffening means as the pleated media without the support of materials of more rigid modulus will tend to be deflected into the engine intake plenum due to the forces developed by the mass flow of intake air required.

Prior art panel pleated media filter elements of large area almost universally have some form of expanded metal opposing the direction of air flow, and sometimes additional bracing across the face of the unit can be found. Frequently, as the surface area of the units became larger than approximately 1 square foot, enclosing sidewalls predominantly of metal in large units and occasionally plastic where a dimension was narrower than approximately 6 inches were required to aid in providing ridgidity to the unit. These internally disposed elements are generally of metals such as steel, zinc, aluminum, and are definitely ecological undesirables upon disposal.

To better understand the teachings of prior art, we define:

the length or alternately the term longitude of the element, to be traditionally in the direction 90 degrees opposite the roots and crests of the pleated media pack, and the width or alternate term, lattitude which is considered to be the direction parallel to the roots and crests of the pleated media pack, and generally is shorter than the length.

In smaller elements, for smaller displacement internal combustion engines where bending moment caused by the fluid mass flow is not a problem, metals have been eliminated, however often integral reinforcing is added by plastics. An example of a disposable element is disclosed in invention U.S. Pat. No. 6,039,779 (Butz, et al) teaches a integral support structure of plastic.

Another U.S. Pat. No. 5,795,361(Lanier,Jr et al) teaches a similar integral support frame of plastic in a disposable element.

Significant progress on metal elimination has taken place in the HVAC type of filter where mass flows are constant and media less subjected to variable flexions.

U.S. Pat. No. 6,074,450(Raber) and antecedent U.S. Pat. No. 4,177,050 (Culbert et al) teach support for pleated flexible air laid filter media. The support comes in the form of non-metallic front and real grilles and individual pleat support fingers. These fingers are disposed in the direction of the length of the filter element, and have no top chord, sacrificing significant stiffness as relative depth of section is decreased and relative length of span is maximized. Also, typical air laid media and paper media for HVAC filters carry far fewer pleats per inch than does media. for internal combustion engine filters. Protruding fingers between each pleat would be difficult to impossible to insert into the densely packed internal combustion engine pleated media pack.

Another significant attempt to produce a non-metallic filter element can be found in U.S. Pat. No. 5,840,094(Osendorf, et al) which specifically teaches pleated paper media for large HVAC panels of the HEPA type. Again, pleat support or separation by protruding fingers into each pleat is taught. and insertion at 90 degrees to root and crest of the pleats. Again fewer pleats per inch are common in HVAC panels relative to internal combustion panels. It is believed that such an arrangement for the assembly with the common closely spaced pleats associated with combustion air for internal combustion engines would preclude use of this support arrangement, in addition there would be a degradation of favorable depth/length of section ratio.

Another significant attempt to provide support for an HVAC air filter element is U.S. Pat. No. 5,531,8929(Duffy)where separation and support is maintained by acute angle wall projections. No support across the entire width is indicated. Again this will not withstand mass flow conditions of internal combustion engines utilizing wide dimensions.

A further support arrangement in U.S. Pat. No. 4,363,643(Elbrader et al) which consists of a wire form for supporting a HVAC fibrous media. The individual cross wires do support the media across the entire crest and root of the width but provide for relatively few pleats, therefore it is infeasible for the closely spaced pleats typical in internal combustion filter elements.

In addition, unless the wire were excessive in diameter, or otherwise supported, long spans across the width would be easily deflected, allowing for excessive deflection in the pleated media element.

Support members disposed across the width direction may be further supported by joining to stringers disposed in the length direction to provide support for what is essentially a floor support.

One patent which illustrates this standard building construction practice is U.S. Pat. No. 5,291,836(Beamer) which is entitled Spacer Assembly, but bears significant design characteristics necessary for a successful support structure for a pleated media filter element. It teaches widely spaced width and length members joined to promote crossflow of air, and also mentions environmental attributes. The loading of the structure is normal with respect to gravity, as loading on a pleated media pack would be normal with respect to airflow. Loading is uniform in compression bearing only and fully supported, so stiffness considerations are not especially manifest, but stiffness considerations would be the dominant parameter in design of a support structure for pleated filter media for internal combustion engines.

Previously discussed patents and unreferenced patents in the field teach toward inserts between pleats as elements for separation, not support. Others teach primarily spacing. Most involve HVAC type filtration. Typical of these include:

1. U.S. Pat. No. 6,045,597(Choi) which teaches a support/spacer is expected to be internally fixed and therefore expended with a disposable filter assembly. The spacer/support is taught to be made from low elastic modulus material primarily of plastic and does not maximize section modulus nor maximize depth/length ratios, however it is disposed in the width dimension of the filter.

2. U.S. Pat. No. 6,036,752(Reuter) teaches a support/spacer means expected to deform in a predictable manner.

It is again a HVAC type filter with system characteristics of steady air flow and low velocities, making it unsuitable for the oscillation of the internal combustion engine airflows. The glued pocket arrangement would probably be prone to fatigue and failure under the conditions characteristic of the internal combustion engine intake.

3. U.S. Pat. No. 2,479,722(Brixius) is an older system utilizing a combination of supporting mesh screen and wire spacers, expensive to manufacture and low in pleat count per inch, and generally displaced by more modern HVAC materials and media, but does have some of the attributes of structure illustrated by (Beamer, U.S. Pat. No. 5,291,836), although the spacer/separators are obviously non-bearing.

Teachings Regarding Sealing

Basic sealing methods include face sealing, where a gasket is emplaced between the filter element and a projection on the filter housing, and compressed by another element of the assemably, and a radial, annular, or lip-type seal by which sealing is effected by the outer perimeter of the filter being pressed against the side of the plenum. Occasionally one sees a combination of the aforementioned methods.

A seal may be integral to the filter element whenever it is molded in place, or is applied as a separate gasket element, often by adhesive. Occasionally one sees a separate gasket, however this is risky as sometimes it is lost, or misaligned, resulting in seal leakage.

One sealing system of the face type is disclosed in U.S. Pat. No. 5,944,860(Mack,et al) for HVAC filters where. sealing surfaces of the two components' sealing flanges mate with the mating surface of the duct flange to form a relatively air-tight seal”. In a later disclosure, U.S. Pat. No. 6,126,708(Mack et al), attached gasket made of resilient material such as low permeability urethane foam can reduce the amount of air leaking between edges and end panels”

Another face type seal is taught by U.S. Pat. No. 3,999,969(Shuler) where an unguided separate gasket is held between the face of the restraining flange and the face of the filter element. This design lends itself to mis-alignment and improper sealing.

Face seals alone tend to have less than maximum sealing effectiveness, unless some method of compression pressure control is inherant. Many of older seals were of rubber which tended to be quite forgiving of overpressure. Modern seals tend to be of polymers or elastomers, and more often tend to be foamed variants of these. These newer seals tend to be less forgiving of overpressures, as significant plastic creep, stress cracking, or other failures result from overpressure, and unsealed face areas or gaps result from under compression.

One example of a compression control arrangement to properly load the gaskets is disclosed in (U.S. Pat. No. 3,740,934) Shuler which utilizes draw bolts loaded against springs to control the pressure on the gasket. This method entails several machined parts, a spring, and a metal stamping and would be relatively expensive to manufacture due to the number of parts required and probably difficult to use under outdoor field conditions.

Radial seals are not often applicable to the flat panel air cleaner, although some face seals will have embossed peaks and valleys arranged on the face which act in the manner of a radial seal.

Annular seals are taught by U.S. Pat. No. 5,730,766(Clements) in which a non-round filter cartridge is pressed into a corresponding non-round housing that is slightly smaller overall, thus compressing the flexible material of the end cap effecting a radial seal. This arrangement seems to have at least one embossed peak which effectively forms a molded in O-ring.

Another annular sealing method is taught by U.S. Pat. No. 5,964,909(Brunner) where a filter unit is disposed in a cavity, and a sealing sleeve is disposed between the flexible end cap and a sealing plug, which is forced into the end cap past the sealing sleeve effecting a seal by reason of the compression of the sealing sleeve displacing material against the wall of the cavity. This obviously involves an extra part in the sealing sleeve and looks adaptable primarily to round and relatively small units.

### OBJECTS AND ADVANTAGES OF THE INVENTION

Principal objects and advantages of the improved air cleaner assembly include:

1. It is one objective to eliminate metals internal in the pleated paper panel air cleaner element itself.

2. It is another objective to reduce the number of parts required to manufacture the present air cleaner element, thus saving materials and labor for the assembly of the present air cleaner element.

3. It is a further objective to reduce the weight and increase the density of disposable materials eventually requiring disposal in a landfill site or at the incinerator.

4. It is a further objective to eliminate or limit to trace amounts plasticizers and chlorine based materials integral to the disposable element which can become PCB precursors upon disposal.

5. It is still another objective to provide a filter element with a seal which effectively prevents leakage of unfiltered air into the plenum exit.

6. It is a mandatory objective to provide a system of retrofit of existing installations at a one-time minimum cost.

7. It is another objective to increase the effective filtration area of the panel by elimination of blocking stiffener sheet metal strips and expanded metal facings.

8. It is a mandatory objective to provide a construction which can be incorporated into new production of air cleaner assemblies with little change and at reduced manufacturing cost which will accept the improved replacement air filter element.

9. It is a final objective to maintain the properties of strength and ruggedness of the metal portions of the air cleaner element by transferring them from forming an internal skeleton which is disposed of in a spent air cleaner element, and hence becoming ecologically more undesirable waste upon disposal, to the interior of the air cleaner assembly housing as a permanent exoskeleton support structure, thereby reducing the environmental load to primarily organic materials which will decompose or incinerate under proper conditions to benign elements.

### IN SUMMARY

The advantages of the improved invention: i.e., Environmental compliance with forthcoming and existing regulation, significantly reduced disposal costs, reduced manufacturing cost of the disposable air cleaner element, a reasonable one-time retrofit cost for units already installed in the field, ease of incorporation of the improvement in new manufactured air cleaner assemblies, reduced shipping weights of disposable panel filter elements, and savings of strategic materials are readily appreciated.

Further objects and advantages of the improved air cleaner assembly will become apparent from a consideration of the drawings and ensuing description.

### DESCRIPTION OF DRAWINGS

FIG. 1. is an exploded view of a prior art disposable pleated media panel air filter assembly

FIG. 2. is a perspective view of one embodiment of an improved disposable pleated media panel air filter having no metal parts and chlorine bearing material or plasticizers.

FIG. 3a. is a sectional view of the filter of FIG. 2, showing detail of the embodiment of a molded in place gasket and joining of pleated media pack and molded in place gasket by direct molding of gasket to the pleated filter media

FIG. 3b. is a section view of the improved filter of FIG. 2, showing detail of the embodiment of a premolded gasket assembled to the pleated media by filler material

FIG. 4a. is a cross section of one embodiment of a molded in place gasket.

FIG. 4b. is a cross section of one embodiment of a premolded gasket

FIG. 5. is a perspective of a prior art plenum and mating retaining frame.

FIG. 6. is a section of the prior art plenum with prior art pleated media panel element enclosed between mating surfaces of the plenum and retaining frame.

FIG. 7. is a front view of an alternate embodiment of a supporting structure formed from wire for the non-metal bearing pleated media filter element of FIG. 2.

FIG. 8. is a front view of the preferred embodiment of a supporting structure formed as a sheet metal stamping for the improved pleated media filter element of FIG. 2.

FIG. 9. is a side view of the preferred embodiment of a supporting structure detailing longitudinal stiffener support for the non-metal bearing pleated media filter element of as shown in FIG. 2.

FIG. 10. is a plan view of the preferred embodiment of a supporting structure for the pleated media panel filter element of FIG. 2.

FIG. 11 is a sectional view of the compression spacer with return hem shown in the exploded view of the improved air cleaner assembly of FIG. 13.

FIG. 12. is a rear view of the retaining frame of prior art showing the open area and compression surface of prior art FIG. 6.

FIG. 13. is an exploded view of the improved air cleaner invention as retrofitted into prior art plenum chamber and retained by a prior art retaining member.

FIG. 14 is a rear view of a modified prior art plenum suitable for new unit production.

FIG. 15. is a rear view of a prior art retaining frame, for new unit production modified by adding cross welded wires as a restraint mechanism in the event of backfire of the engine.

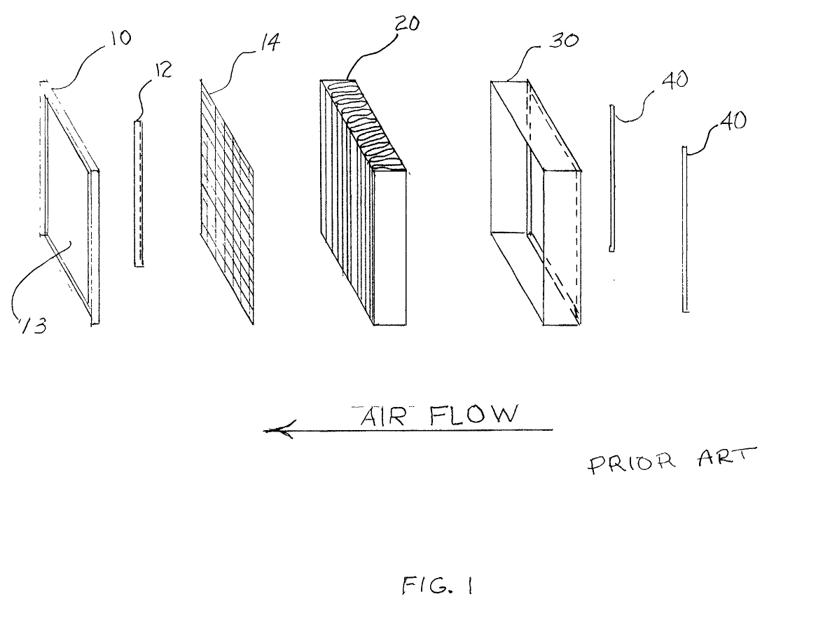

### LIST OF REFERENCE NUMERALS

10. Prior art gasket, panel filter element

12. Prior art sheet metal front brace, panel filter element

14. Prior art expanded metal face reinforcement, panel filter element

20. Prior art pleated media pack, panel filter element

20a. Pleated media pack assembly, with edge gluing improved panel filter element

21. Molded in place gasket, gasket to media pack bond, improved panel filter element.

21a. Premolded gasket

22. Edge of random excess molded in place gasket material

22a. Edge of random excess joining filler material

22b. Joining filler material

23. Bottom of molded in retaining groove for hem of compression spacer, improved air cleaner assembly

24. Compression sealing surface, improved panel air filter element.

25. Filter air exiting area, improved panel filter element.

26. Standoff for media pack, premolded gasket

27. Retaining groove for hem of compression spacer, improved air cleaner assembly.

28. Dam element, premolded gasket

29. Aperture, compression control stop member clearance

30. Weldment, edge enclosing strip steel, prior art air cleaner assembly

40. Prior art reinforcing steel strip, anti-backfire support, panel filter element

50. Prior art plenum chamber, intake side

50a. Plenum, girder truss modification, new production, improved air cleaner assembly.

51. Open area, intake, retaining frame, prior art

52. Compression area, rear side, retaining frame, prior art

53. Weldment, compression area, filter element retaining, plenum, prior art

54. Inlet side surface, weldment, compression area, filter element retaining, plenum, prior art

55. Additional plenum functions, prior art

56. Retaining frame, prior art

56a. Retaining frame, new production modification, improved air cleaner assembly.

57. Intake face of weldment, compression area, filter element retaining, plenum, prior art

58. Latching assembly, prior art

59. member, anti-backfire, modified new production retaining frame

70. Field installed stiffener support, wire form, complete, improved air cleaner assembly

71. Top sealing surface, field installed stiffener support, improved air cleaner assembly

72. Top of truss form welded wire embodiment field installed stiffener support improved air cleaner assembly

73. Polymer or elastomer molded on gasket, field installed stiffener support, improved air cleaner assembly

74. Longitudinal cross welded wire, to truss form welded wire embodiment field installed stiffener support, improved air cleaner assembly.

79. Bottom sealing surface, field installed stiffener support, improved air cleaner assembly

80. Field installed stiffener support, sheet metal form, preferred embodiment complete, improved air cleaner assembly.

81. Top sealing surface, field installed stiffener support, sheet metal embodiment improved air cleaner assembly.

82. Top of girder truss formed by sheet metal, field installed stiffener support, sheet metal embodiment improved air cleaner assembly.

82a. Bearing surface of pleat in tension

83 Polymer or elastomer molded on gasket, field installed stiffener support, sheet metal embodiment improved air cleaner

84. Longitudinal purlin-type member joined to sheet metal girder form field installed stiffener support, improved air cleaner assembly.

85. Truss, sheet metal formed girder

87. Clearance aperture

88. Joining tab, girder truss form sheet metal field installed stiffener support, improved air cleaner assembly.

89. Bottom sealing surface, girder truss form sheet metal field installed stiffener support, improved air cleaner assembly.

90. Compression member, field installed, complete, improved air cleaner assembly.

91. Air inlet opening, compression member, improved air cleaner assembly

92. Sealing surface, compression member, improved air cleaner assembly

93. Rounded edge of return hem, compression member, improved air cleaner assy

94. Return hem, compression member, improved air cleaner assembly.

96. Stop, gasket compression control

99. Anti-backfire support member, compression member, improved air cleaner assembly.

### SUMMARY

The invention is an improved air cleaner assembly for large engines employing panel type air cleaners of the disposable type. The invention improves upon prior art by devising a structural method of substituting permanent field modifications and new production modifications for support and improved sealing, thereby eliminating integral metal parts from the filter element which now, having fewer parts, costs less to manufacture, weighs less, and costs less to dispose of due to removal of ecologically undesirable components.

Long run cost savings are expected to ensue upon retrofit, as the modified disposable filter element is less expensive to produce, ship, and especially to dispose of.

### DESCRIPTION OF THE INVENTION

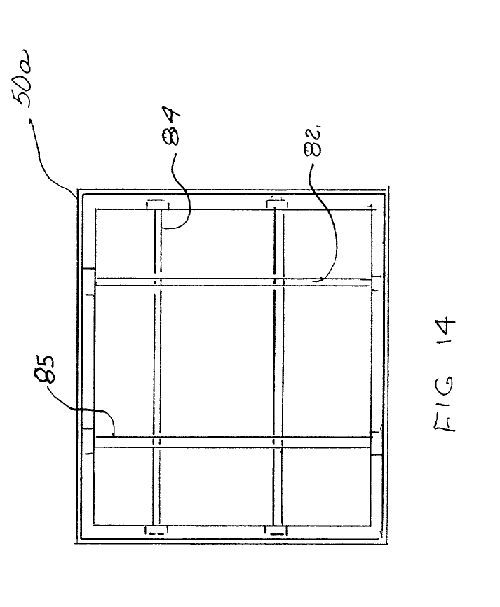

A preferred embodiment of the invention is illustrated in the exploded drawing of FIG. 13.

A prior art plenum chamber (50,55) already has a compression area weldment (53) opposing the flow of incoming air. This compression weldment(53) has, opposing the airflow and normal to it, an intake face(57).

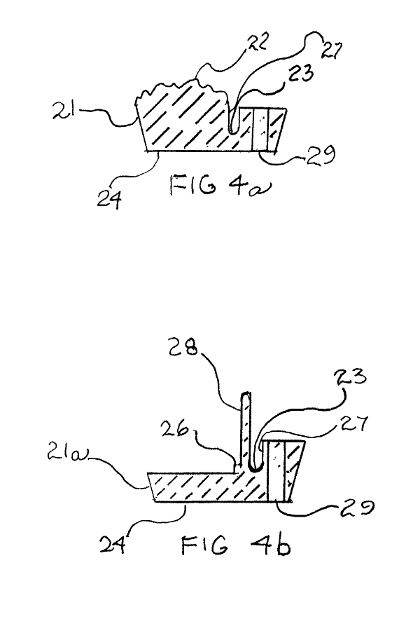

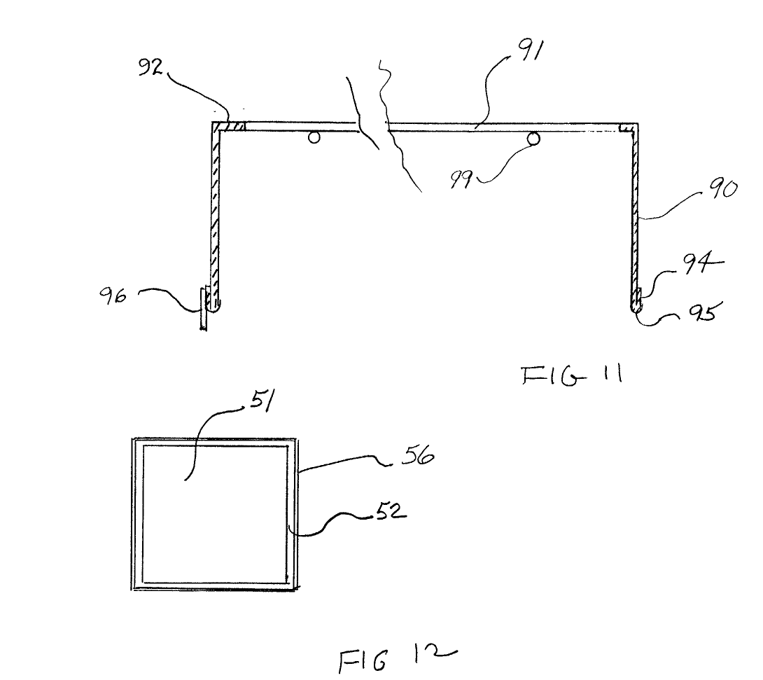

An edge-glued media pack assembly(20a), with molded in place gasket, is pre-assembled with a compression spacer(90) of FIG. 11. The hem(94) of the compression spacer is sized to fit into the edge-glued media pack of FIG. 4 into the retaining groove(27), and to stop on the bottom of the molded in retaining groove(23).

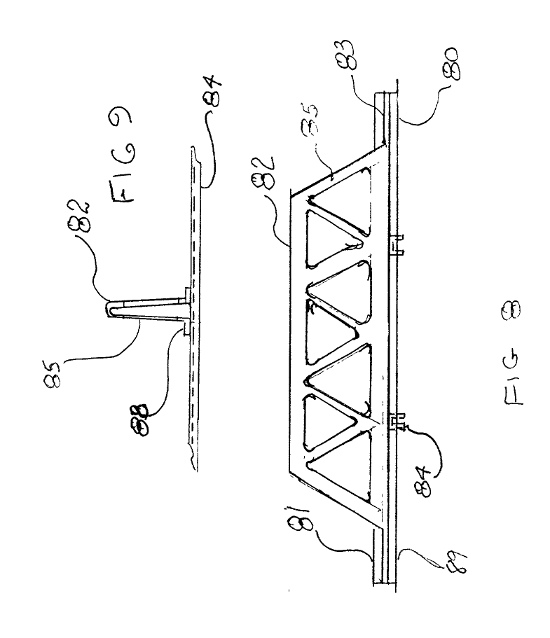

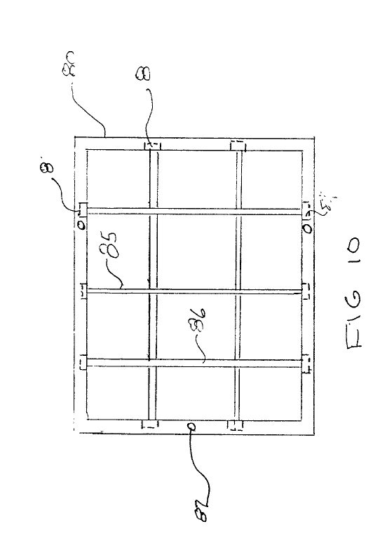

A field installed stiffener support is centered on the edge-glued media pack assembly(20a) by inserting the tops of the plural respective girder trusses(82), between openings in the filter air exiting area (25), between pleats of the edge-glued media pack assembly (20a), until the top sealing surface (81) of the field installed stiffener support of FIG. 8, abuts the compression sealing surface(24) of the molded in place gasket (21) of the edge-glued paper pack assembly (20a). Care must be taken to ensure the plural compression control stops(96), clear both apertures(29) and clearances(82) so that proper compression on gasket(21) is maintained within designed limits.

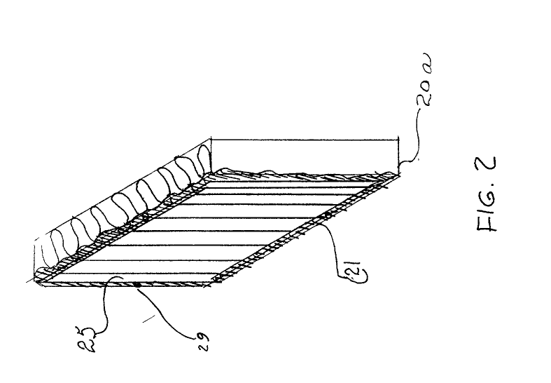

The preassembled unit of field installed stiffener support (FIG. 8), edge-glued pleated media pack assembly(FIG. 2), and compression member (FIG. 11), is then inserted into the intake side of the prior art plenum(50) until the bottom sealing surface(89) of the polymer or elastomer molding abuts the intake face of the compression area weldment(57) of the plenum chamber(50).

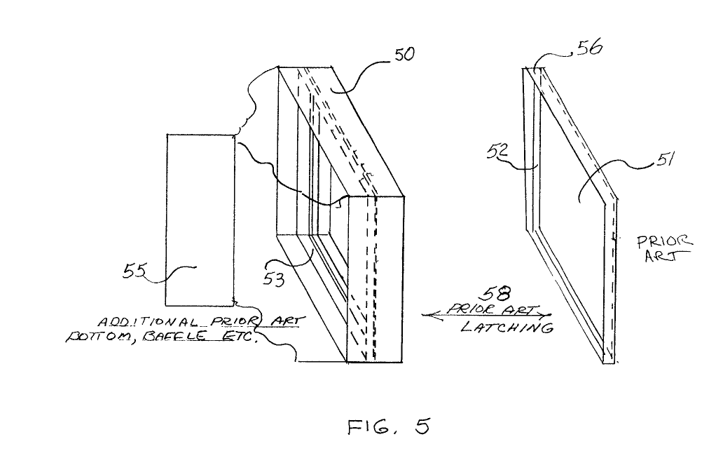

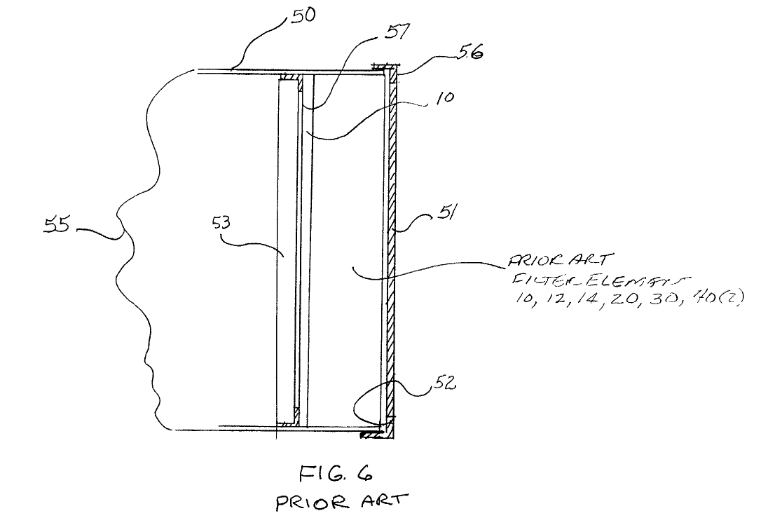

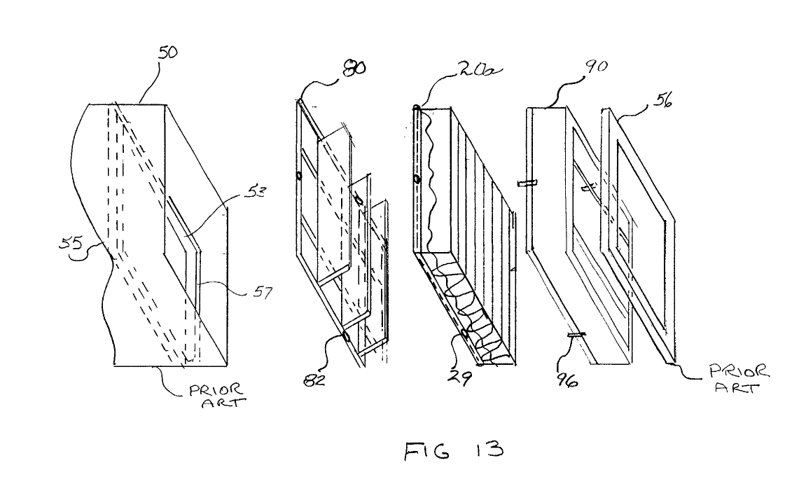

A retaining frame of prior art (56) is placed abuting the sealing surface(92) of the compression member of FIG. 11, and is attached to the plenum chamber (50), by means of prior art latching assemblies(58), of FIG. 5. The latching assemblies, typically of screw thread and nut bracket nature are tightened until compression of the four sealing surface pairs, respectively: intake face of weldment(57) and bottom sealing surface stiffener support,(89); top sealing surface stiffener support(81) and compression sealing surface of improved panel filter element(24); bottom of molded in retaining groove for hem(23) and top of return hem(94); sealing surface compression member(92) and compression area of rear side of retaining frame(52), of FIG. 12 develop sealing by compressive resistances, said compressive resistances being controlled by the plural stops(96), thereby defining a plane, and equalizing pressures at all mating surfaces of assembly members, and simultaneously control the amount of gasket compression preventing seal failure due to overpressure, such as subsequent material creep, or potential compressive stress failure, or conversely, seal failure due to underpressure such as leakage between faces of various sealing surfaces due to air gaps.

Now that the process of field assembly and proper installation of the unit has been explained, various attributes of individual members of the total assembly will be illustrated.

### Theory of Stiffener Supporting Structure

The aforementioned problem of control of excessive flexure in long structural spans is a standard civil engineering consideration. It is believed that application of civil engineering principles would lead to a development of a superior supporting member for the roots and crests of a pleated media pack.

Initially, the standard engineering truss would seem applicable for support for the crests of the pleats. Any typical system would work, so long as there is a substantially continuous top chord. Candidates include the Howe, Pratt, Warren, and indeterminate forms such as the Vierendeel types, among others. End treatment of the truss would favor ends similar to Queen Post types where the ending triangular panels naturally form a lead-in for its insertion within pleats.

The truss approach to pleat support, as the depth of pleats needing support in the direction of crest width are often in the range of 2 to 5 inches, which for a truss of 24 inches long, for example, provides a section depth/length of span ratio which naturally promotes adequate stiffness so long as sufficient material is placed in the bottom chord.

Additionally it can be recognized that the natural openness of a truss makes that form of engineering support section an ideal candidate where maximum airflow is desired through the filter pack.

Support members disposed across the width direction may be joined to stringers disposed in the length direction to provide support for what essentially becomes analogous to a floor framing system or an inverted roof system utilizing bar joists for width support and purlin-type stringers for length support. The inverted roof analogy assumes mass flow forces are developed normal to the inversion. Hence, the bar joists protrude into the media pack, against airflow, holding a minority of pleats in tension, while the majority of pleats are supported by the purlin and are held by compression.

The compression naturally leads to a buckling at right angles to the roots and crests of the pleats. This tendency to buckle is overcome in floor framing systems and some roof systems by bridging between joists. As this bridging if applied conventionally would extend into and interfere with a dense media pack, it is not feasible to control lateral buckling in this manner. Fortunately, the dense media pack, particularly if it has spacers between pleats, acts as bridging. The spacer between pleats need be no more than an embossed section of the media which is commonly applied in such pleated media materials.

### A Preferred Embodiment of a Field Installed Stiffener Support

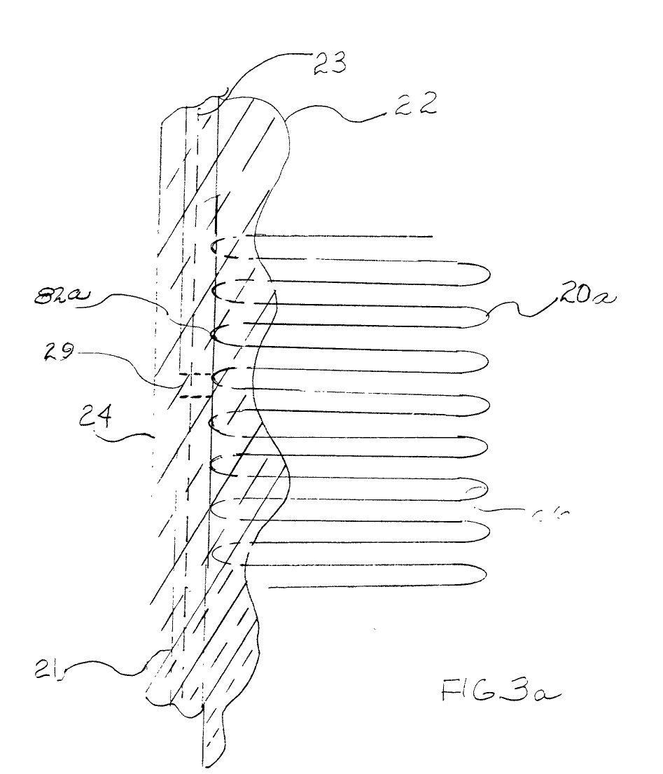

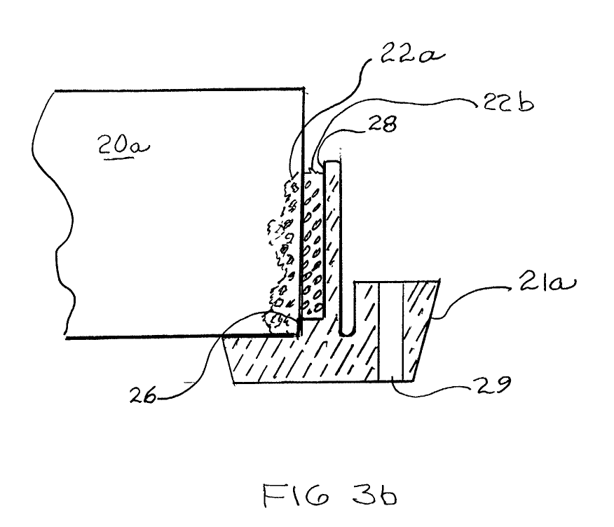

A preferred embodiment of a field installed stiffener support(FIGS. 8,9, and 10), is fabricated by joining a plurality of sheet metal formed girder truss (85) to at least one longitudinal stringers(84), and submerging the joining tabs(88) by molding on a polymer or elastomer gasket(83) in a manner that develops a smooth top sealing surface(71), and a smooth bottom sealing surface(79). Of particular note is that forming of the truss(85), should be done so that any burr formed during manufacture is turned opposite the bearing surface of the top of girder truss (82) so as not to present potential wear points on the pleat inner tension inner bearing surface(82a of FIG. 3a). The thickness of the material which is preferably of galvanized steel for the truss(85) will obviously vary according to area of the panel, but typically would fall between 0.8 mm and 1.2 mm, and the effective width of bottom chord(86) fall in the range of 12 to 16 mm. The stringer(84) is illustrated as a channel type member, but can be of any structural shape including an inverted truss(85) so long as stiffness requirements and clearances for depth is available. Preferred material for stringer(84) is galvanized steel with a thickness between 0.8 mm and 1.2 mm. Before molding on gasket(83), the joined metal support structure less gasket(83) may be coated with a powder or liquid applied organic coating, for example, polyester, polyurethane, epoxy, or blends of polymer which will enhance resistance to corrosion and also decrease the coefficient of friction at the top chord bearing surface(82).

It is of particular importance to provide clearance apertures(87), disposed so that there is not interference to enable each gasket compression control stop(96) to bear against the inlet side of the compression weldment (54), thereby establishing compression dimension slightly less than the combined thicknesses of gasket(83) and the thickness existing between the bottom of molded in retaining groove(23) and the compression sealing surface of the improved air cleaner element(24). Thus, it becomes possible to ensure that it is not possible to overtighten prior art latching assembly(58), thereby setting up overstress on polymer or elastomer gasket(83) or on alternative embodiments premolded gasket(21a) or molded in place gasket (21). Such overstress could lead to compressive set of the material or creep or other damages such as cracking leading to seal failure.

Great care should be taken to avoid improper positioning of members such that stop(96) does not clear apertures (29 and 87) and therefore fails to seat against weldment(54) due to interference with gasket (21a or 21) or gasket(73 or 83). This would not allow the gasket material to properly compress, setting up improper compression, or leakage lines between gasket faces, thus causing sealing failure.

### An Alternative Preferred Embodiment of a Field Installed Stiffener Support

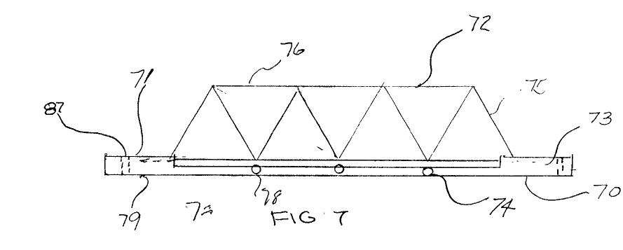

In some instances, an alternative preferred embodiment of a field installed stiffener support in the form of a welded wire form would be preferred. One such embodiment is illustrated in (FIG. 7). The plurality wire form trusses (75) are preferably fabricated as a weldment on automated equipment. The top chord of truss form welded wire embodiment should be welded in a manner which does not impair the surface quality of the bearing surface(76), which if improperly welded could create rough points or weld squirt that could lead to excessive wear and subsequent weakening of the media pleat pack(20a) at the bearing surface of a pleat in tension(82a of FIG. 3a). Preferred materials would include pregalvanized hard-drawn wire in the size range of approximately 2 mm to 3 mm. A plurality of longitudinal support stringers(74) are joined to trusses(75). Stringers(75) may be of wire in the diameter range of 2 mm to 3 mm, or could be a non-wire structural shape, one of which is illustrated in FIG. 8 as stringer (84). Before molding on the polymer or elastomer molded on gasket(73) the wire form field applied stiffener support (70) may be further protected from corrosion and the surface coefficient of friction reduced by applying an organic coating in a powder or liquid form. The wire form stiffener support(70) is completed by molding on and completely submerging the ends of the stiffener support(78) within the molded on gasket(73), thus creating smooth top sealing surface(71), and smooth bottom sealing surface(79). Again, it is important to provide gasket(73) with apertures(83), so disposed as to enable the proper clearance to be established for prevention of overstress of gasket materials as well as proper sealing pressures as previously explained.

### A Preferred Embodiment of the Improved Filter Element

One preferred embodiment of the improved filter element consists of a pleated media pack with edge gluing(20a), which is assembled to a premolded gasket(21a), by application of a joining filler material(22b). The filler(22b) typically is a hot melt product or reactive material such as polyurethane, and would have substantial adhesive properties. While moving the preassembled filter element or the adhesive dispensing head around the perimeter of the dam element(27), a,controlled excess of filler(22b) would be flowed into spaces between the pleats assuring satisfactory bonding of pleat pack(20a) and gasket(21a), being restricted by the premolded dam element(28), and stopping as some random edge of excess joining material(22a). An volumetric space is created for insertion of filler material (22b), by fitting the media pack (20a) against the standoff for media pack of the premolded gasket(26) in a preassembly fitup before application of filler(22b).

The premolded gasket should be molded from non-chlorine bearing polymer or elastomer and should not contain more than trace amounts of PCB precoursers, ecologically undesireable plasticizers or other environmentally unsuitable components.

Of primary importance is the creation of the retaining groove for the hem of the compression spacer(27). This groove(27), has a molded in bottom(23), which with the compression sealing surface(24) has the function of providing a repeatable dimension so that the amount of compression of all gaskets(83 or 73, and 21a) respectively can be set up by the length of the compression control stop(96).

Of particular importance is molding a plurality of compression control stop member clearances(29) in the gasket(21a) so disposed as to accept each gasket compression control stop(96) without interference so that proper compression on gaskets(21a) and (83) or(73) may be obtained without danger of seal failure due to over or under compression as previously explained.

### An Alternative Preferred Embodiment of the Improved Filter Element

An alternative preferred embodiment of the improved filter element consists of the assembly of a pleated media pack assembly (20a) by placing the media pack(20a) in a suitable mold and molding by any one of various common means a molded in place gasket(21), The material for such a gasket(21), may be from one of many polymer or elastomer systems such as polyurethane, or foamed hot melt materials, for example. One must avoid materials deemed inappropriate for waste disposal such as polyvinyl chloride and its plasticizers Substantial adhesion would be obtained by flowing a controlled excess of expanding material into spaces between pleats as indicated by the edge of random excess molded in place gasket material(22).

Again, of particular importance is the creation of the retaining groove(27), obtained by a mold element, thus creating repeatability in manufacture so proper compression of gaskets(21 and 83 or 73) can be assured.

Aperture(29), is created by a mold element properly disposed so as not to cause interference between the finished improved air cleaner element of (FIG. 2) and stop(96).

### A Preferred Embodiment of a Field Installed Compression Member

The compression member(90) preferably is made of metal and has a return hem(94), disposed on all four sides so that when installed onto an improved air cleaner element of (FIG. 2) it may fit within groove(27) creating an air tight seal in the manner of an annular seal, and simultaneously the rounded edge of the return hem(93) abuts the bottom of the groove(23), thereby establishing a diffuse and even zone of compression when installed.

The compression member(90), carries a plurality of stops(96), whose function has been previously disclosed. These stops(96), may be joined to the compression member(90) by welding or other means. The length of the stops is determined by the limiting parameters of compression required to effectively seal the unit while staying under limits of overstress for the materials forming gasket(21 or 21a and 83 or 73).

Additionally the compression member(90) has joined to it across the air opening inlet, a plurality of anti-backfire support members,(99), which may be disposed laterally, longitudinally or in both directions, spaced just above the crest of the pleats of the improved air cleaner element of

(FIG. 2), with the intent of not creating a pinch or wear point on the crest of the pleat pack between the truss top(82 or 72), and the member(99). These members(99) preferably are of wire, but may be of any convenient design.

### New Plenum and Frame Modifications

The invention primarily is disclosed is an assembly consisting of an improved filter element and the transfer of internal structural elements to an exoskeleton and improving sealing pressure control and changing of materials to less environmentally damaging elements, for a retrofit to tens of thousands of units already installed throughout the world.

It will also be necessary to change the new production, and although this is not the objective of this invention, such modifiction is possible and necessarily would be expected in the long run.

One way to accomplish this is to make support and sealing compression control requirements an integral part of new plenum and retaining cover respectively.

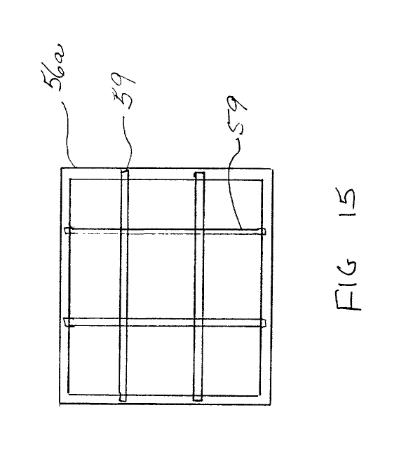

FIGS. 14 and 15 illustrate one preferred embodiment of such changes.

In FIG. 14, new production modified plenum (50a) has be fabricated from an old production plenum(50), by directly joining a plurality of trusses (85) and at least one purlin(84) to the outlet face of weldment(53). This would provide a flat surface(54) that would not require a gasket(83). Compression on only the gasket(21 or 21a), gasket (83) having been eliminated, would require decrement of the length of compression control stop(96) in order to effect proper sealing. Since only the improved filter element(of FIG. 2) would be interchangable between variant plenum/cover pairs, compression control would be again a factor of fixed length of stop(96).

FIG. 15 illustrates one embodiment of a plenum cover or retaining frame (56a), which consists of old retaining frame(56) with joined members anti backfire(59) laterally, longitudinally or both as desired by the manufacturer.

Between the new production frame (56a) and the bottom of the groove(23) of improved filter element (of FIG. 12), would be a compression member(90). Member(90) could preferably be joined permanently to frame(56a) or alternately be left as a loose member.

### Conclusions, Ramifications, and Scope

As disclosed, the reader will understand that a large pleated media filter element containing no internal metal parts or ecologically undesireable organic compounds is a distinct improvement over prior art from both a manufacturing cost standpoint and more importantly ecologically. The need for integral support of densely packed pleated media has been overcome by retrofitting a reusable external support, thus enabling the improved pleated media filter element to function.

The benefit of the improved disposable filter element containing no or only trace amounts of chlorine bearing organics and plasticizers from an ecological basis is not only good for the environment, but will surpass existing and meet even more stringent regulation and law just over the horizon.

Also, the important attribute of the improved air cleaner assembly—sealing has been improved by providing a simple means for controlling compression of gasketing, clearances where necessary to avoid misassembly, and thereby retaining the loaded gasketing within design limits, without extra parts such as tie rods, springs, and other cumbersome fastenings.

Significant weight has been removed from the disposable filter element by elimination of metal parts, and heavy filled adhesives, by substitution of lighter foamed gaskets and adhesives. Also, overpackaging, such as the paperboard shipping containers have been reduced in size as typically four old units were packed in a box approximately 9 inches high. Since there in now no full metal enclosure on the sides, it can be seen that the standing pleats of two filter elements may be interleaved back-to back, thus reducing the volume required to pack four units, and a corresponding packaging cost reduction, and importantly, a reduction in the amount of packaging material becoming waste. The package will now approximate 5 inches in height.

In order to have proper disclosure, the above description contains many specifics, however these should not be construed as limiting the scope of the invention but as illustrations of some of the presently preferred embodiments of this invention.

Accordingly, the scope of the invention should be determined by the appended claims and their legal equivalents, rather than by the specific examples given.

I claim:

1. An improved disposable pleated media panel filter element, containing no metal structural elements, of such width, length, section modulus, and resistance to applied fluid flow and resultant flexure that it requires external support.

2. The improved disposable pleated media panel filter element of claim 1, wherein said filter element whose integral gasket is provided with apertures whereby gasket compression control members may be entered as means to control face sealing pressure.

3. The improved disposable pleated media panel filter element of claim 1 is disposed upon an external support whose latitudinal members are of truss form as means to control flexure.

4. The improved disposable pleated media filter element of claim 1 whereby a minority of the pleats are loaded in tension and a majority of pleats are loaded in compression respective the external support and pressure developed by fluid flow.

5. The improved disposable pleated media filter element of claim 1 contains a groove as a means of distributing annular sealing pressure.

6. The improved disposable pleated media panel filter element of claim 1, wherein said filter element has substantially no chlorine content.

7. The improved disposable pleated media panel filter element of claim 1, wherein said filter element has substantially no ecologically undesirable organic compounds.

8. In an air cleaner assembly, consisting of a plenum with a face sealing surface, an improved pleated media panel filter element containing no metal parts or ecologically undesirable organic compounds, an external support for said pleated media panel filter, a compression member, a retaining frame and fastening means:

9. Said external support of claim 8 for said pleated media panel filter is generally of a truss and purlin form.

10. Said external support of claim 8 is assembled from formed sheet metal members.

11. Said external support of claim 8 is assembled from wire formed members.

12. Said external support of claim 8 is made from polymer materials.

13. Said compression member of claim 8 has a plurality of compression control stops as means for regulating gasket face sealing pressure.

14. Said compression member of claim 8 has anti-backfire support members as a means of preventing failure of the filter element caused by a backfire.

15. Said compression member of claim 8 has a hem as means of distributing compression loading over a diffuse area.

16. Said compression member of claim 8 seals within the groove of the improved disposable panel filter element of claim 1 by means of annular sealing between the periphery of the compression member hem and the plenum.

17. Said compression member of claim 8 seals within the groove of the improved disposable panel filter element of claim 1 by means of face sealing between the hem of the compression member and the compression area face sealing surface within the plenum.
